(19) United States
(12) Patent Application Publication
(10) Pub. No.: US 2025/0303861 A1
(43) Pub. Date: Oct. 2, 2025

(54) AUDIO PLAYBACK DEVICES FOR VEHICLE MEDIA PLAYBACK SYSTEMS

(71) Applicant: Sonos, Inc., Goleta, CA (US)

(72) Inventors: Maciej Waskiewicz, Amsterdam (NL); Mattias Jeffrey Scheek, Amsterdam (NL); Naphur van Apeldoorn, Amsterdam (NL)

(21) Appl. No.: 19/094,676

(22) Filed: Mar. 28, 2025

Related U.S. Application Data
(60) Provisional application No. 63/573,210, filed on Apr. 2, 2024.

(51) Int. Cl. B60K 35/26; B60K 35/25; H04R 1/20

(52) U.S. Cl. CPC B60K 35/26; B60K 35/25; H04R 1/20; B60K 2360/77

(57) ABSTRACT

An example headrest assembly includes a headrest body defining a forward surface configured to contact a user's head or neck and an audio playback device disposed within headrest body and facing in a forward direction. The playback device includes a left audio transducer, a left waveguide in fluid communication with the left audio transducer and configured to direct audio from the left audio transducer along a left sound axis, a right audio transducer, and a right waveguide in fluid communication with the right audio transducer and configured to direct audio from the right audio transducer along a right sound axis. The left sound axis and the right sound axis diverge along the forward direction.

### CROSS-REFERENCE TO RELATED APPLICATION

This application claims the benefit of priority to U.S. Patent Application No. 63/573,210, filed Apr. 2, 2024, which is incorporated herein by reference in its entirety.

### FIELD OF THE DISCLOSURE

The present disclosure is related to consumer goods and, more particularly, to methods, systems, products, features, services, and other elements directed to audio playback devices for vehicle media playback systems or some aspect thereof.

### BACKGROUND

Options for accessing and listening to digital audio in an out-loud setting were limited until in 2002, when SONOS, Inc. began development of a new type of playback system. Sonos then filed one of its first patent applications in 2003, entitled “Method for Synchronizing Audio Playback between Multiple Networked Devices,” and began offering its first media playback systems for sale in 2005. The Sonos Wireless Home Sound System enables people to experience music from many sources via one or more networked playback devices. Through a software control application installed on a controller (e.g., smartphone, tablet, computer, voice input device), one can play what she wants in any room having a networked playback device. Media content (e.g., songs, podcasts, video sound) can be streamed to playback devices such that each room with a playback device can play back corresponding different media content. In addition, rooms can be grouped together for synchronous playback of the same media content, and/or the same media content can be heard in all rooms synchronously.

### BRIEF DESCRIPTION OF THE DRAWINGS

Features, aspects, and advantages of the presently disclosed technology may be better understood with regard to the following description, appended claims, and accompanying drawings, as listed below. A person skilled in the relevant art will understand that the features shown in the drawings are for purposes of illustrations, and variations, including different and/or additional features and arrangements thereof, are possible.

FIG. 1A shows a schematic plan view of a vehicle environment having a media playback system configured in accordance with aspects of the disclosed technology.

FIG. 1B shows a schematic diagram of the media playback system of FIG. 1A and one or more networks.

FIG. 1C is a block diagram of a playback device.

FIG. 1D is a block diagram of a playback device.

FIG. 1E is a block diagram of a network microphone device.

FIG. 1F is a block diagram of a network microphone device.

FIG. 1G is a block diagram of a playback device.

FIG. 1H is a partially schematic diagram of a control device.

FIG. 2A shows a perspective view of a playback device integrated into a headrest assembly in accordance with aspects of the disclosed technology.

FIG. 2B shows a perspective view of the playback device shown in FIG. 2A.

FIG. 2C shows a partially exploded view of the playback device shown in FIG. 2B.

FIG. 2D shows a front view of the playback device shown in FIG. 2B.

FIG. 3 shows a top view of a headrest playback device relative to a user's head in accordance with aspects of the disclosed technology.

FIG. 4A shows a perspective view of another example playback device for integration with a headrest assembly in accordance with aspects of the disclosed technology.

FIG. 4B shows a top view of the playback device shown in FIG. 4A.

FIG. 4C shows a front view of the playback device shown in FIG. 4A.

FIG. 5 illustrates an example method in accordance with aspects of the disclosed technology.

The drawings are for the purpose of illustrating example embodiments, but those of ordinary skill in the art will understand that the technology disclosed herein is not limited to the arrangements and/or instrumentality shown in the drawings.

### DETAILED DESCRIPTION

### I. Overview

Traditional automobile audio systems often struggle with delivering a clear and immersive sound experience to all passengers, especially those in the rear seats. Disposing speakers within an automobile headrest can beneficially locate a speaker close to a passenger's ears. However, conventional automobile headrest speakers face challenges such as limited space, sound directionality, and interference from cabin noise. There is a need for an approach to overcome these limitations and enhance the auditory experience for vehicle occupants.

The present technology relates to audio playback devices integrated into a vehicle media playback system, for instance being integrated into one or more vehicle headrests. Such headrest-integrated playback devices can include tailored waveguides to provide improved sound quality and directionality for vehicle passengers. In particular, the audio playback devices described herein can provide a more immersive and personal audio experience through precise sound channeling and reduced interference. Key advantages include enhanced clarity, increased volume without distortion, and a personalized listening environment for each seat. Additionally, such playback devices can be designed to be compatible with a wide range of vehicle models and can be easily integrated into existing headrest designs without significant modifications.

In some implementations, an audio playback device for use in a vehicle headrest can include a left transducer configured to output audio along a left sound axis, a right transducer configured to output audio along a right sound axis, and a center transducer. In some examples, the left and right transducers can be identical tweeters or full-frequency transducers, while the center transducer can take the form of a woofer configured to output low-frequency audio content. The audio playback device can be arranged such that the left sound axis and right sound axis extend adjacent left and right sides of a passenger's head when the passenger is seated. In some instances, these sound axes can diverge from one another in the forward direction. This configuration can beneficially achieve enhanced spaciousness while still providing audio sufficiently directed toward the seated passenger for individualized audio output. However, while conventional approaches to headrest-integrated speakers may aim the sound axes directly towards a passenger's ears, such a configuration renders the acoustic perception of the passenger highly dependent upon the passenger's particular head position. Accordingly, when a passenger moves her head, the perceived audio can vary markedly and undesirably. Additionally, since passengers may vary in height, head size, head position when seated, etc., such precise directionality towards a passenger's ears can be difficult to achieve in a uniform manner.

In some implementations, the playback device can be adjustable to tailor the sound directivity for different passenger heights, seating positions, or otherwise. For instance, the transducers themselves can pivot, translate, or otherwise adjust position. Additionally or alternatively, the waveguides associated with one or more of the transducers can be adjusted to alter one or more sound axes of the playback device.

In some implementations, audio playback characteristics can be modified based on a vehicle parameter, which can be obtained via one or more vehicle sensors or other suitable data source. This can include varying audio playback characteristics of only a subset of the playback devices within the vehicle media playback system, for instance varying audio playback characteristics for only a single headrest-integrated playback device or a plurality of such headrest-integrated playback devices. Among examples, the vehicle parameter can include a detected-sound parameter (e.g., detected road noise, speech presence detection, out-loud audio distinct from that being played back via the audio playback device, etc.), a user-presence parameter (e.g., user detected in a vehicle seat coupled to the headrest assembly, user(s) detected in other vehicle seat(s), user detected in proximity to audio playback device and/or to headrest body, etc.), or an audio content parameter (e.g., telephone audio, music, etc.).

In some implementations, audio output can be modified based at least in part on the vehicle parameter(s). Modifying the audio output can include, for instance, performing active noise cancellation, inhibiting audio output via some or all of the transducers of a playback device, adjusting equalization settings of some or all of the transducers of a playback device, adjusting a playback volume, or any other suitable modification to audio playback, whether applied to that playback device alone or in combination with some or all of the other playback devices within the environment.

While some examples described herein may refer to functions performed by given actors such as “users,” “listeners,” and/or other entities, it should be understood that this is for purposes of explanation only. The claims should not be interpreted to require action by any such example actor unless explicitly required by the language of the claims themselves.

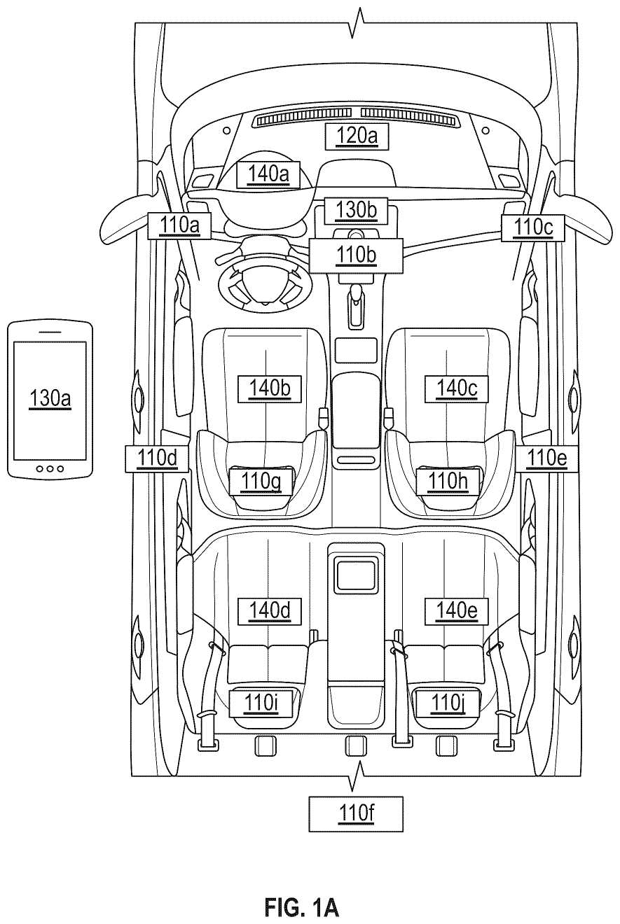

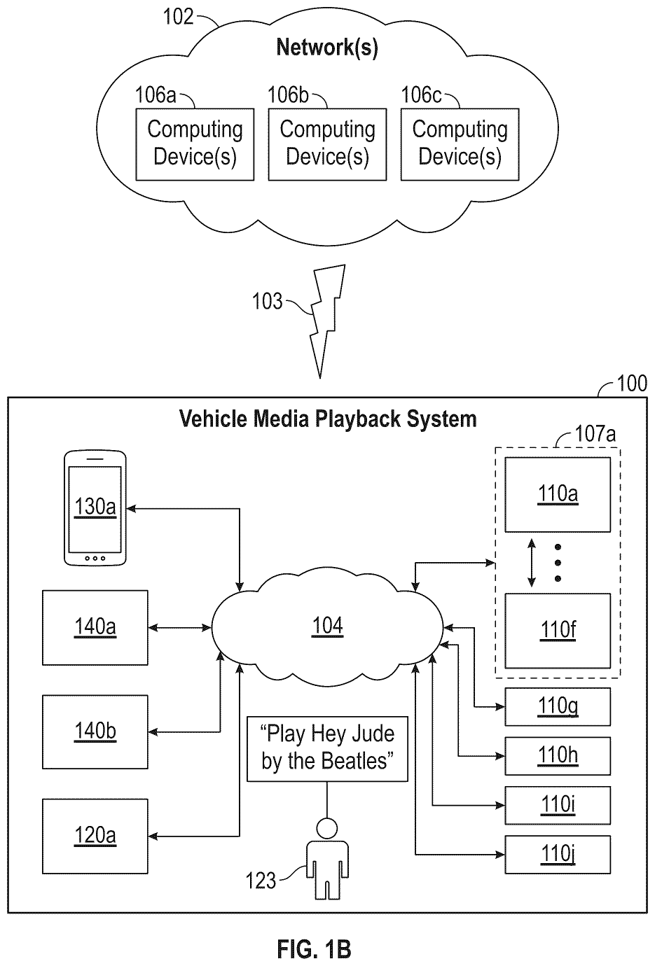

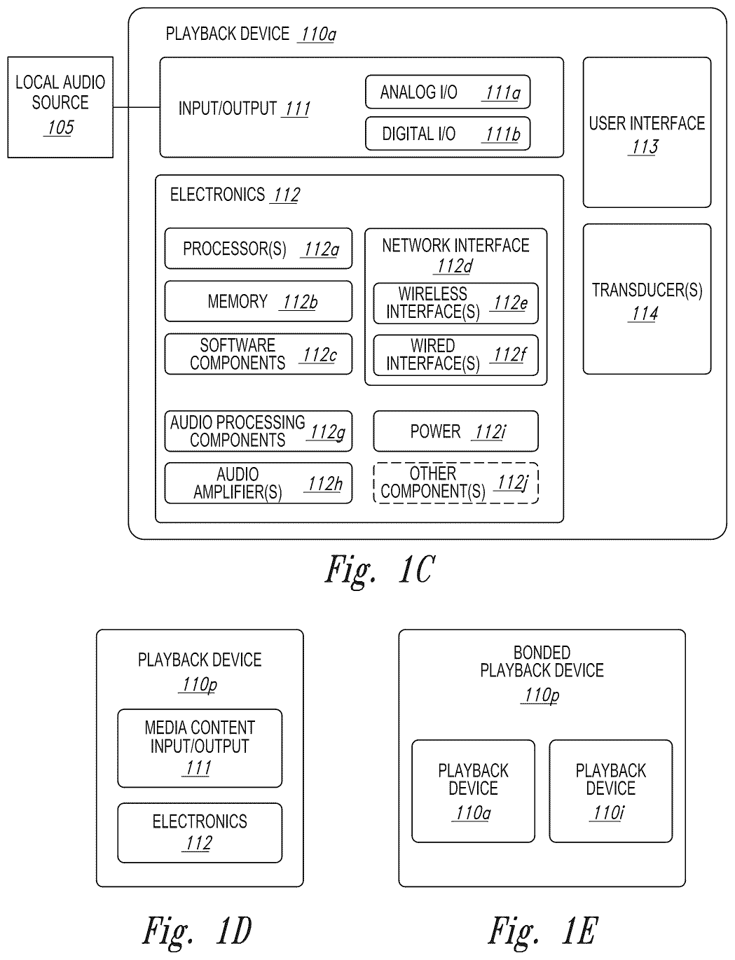

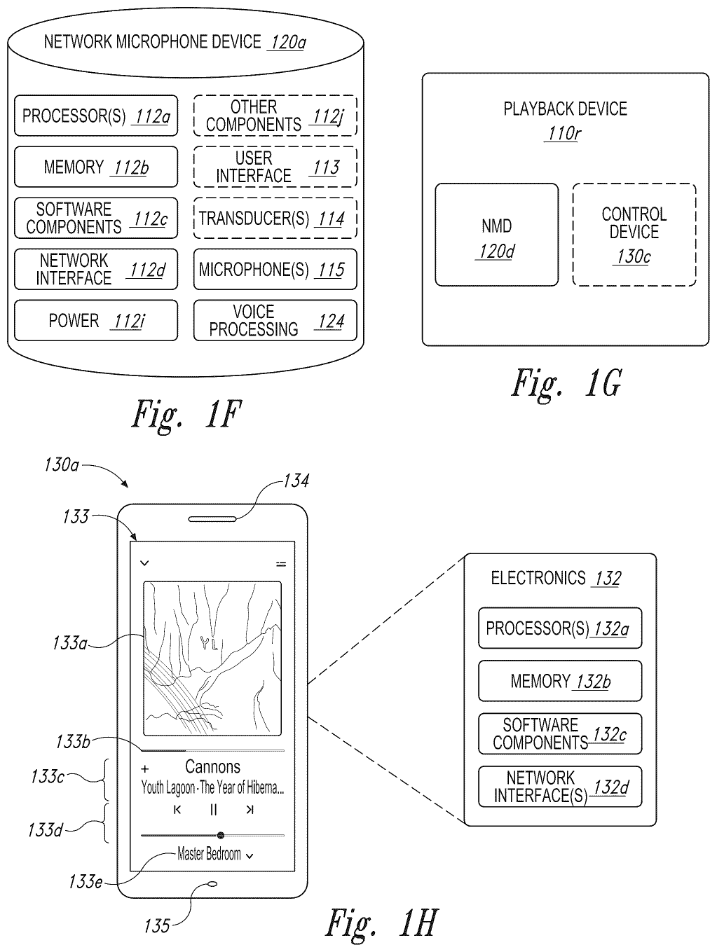

In the Figures, identical reference numbers identify generally similar, and/or identical, elements. To facilitate the discussion of any particular element, the most significant digit or digits of a reference number refers to the Figure in which that element is first introduced. For example, element 110a is first introduced and discussed with reference to FIG. 1A. Many of the details, dimensions, angles and other features shown in the Figures are merely illustrative of particular embodiments of the disclosed technology. Accordingly, other embodiments can have other details, dimensions, angles and features without departing from the spirit or scope of the disclosure. In addition, those of ordinary skill in the art will appreciate that further embodiments of the various disclosed technologies can be practiced without several of the details described below.

### II. Suitable Operating Environment

FIG. 1A is a partial cutaway view of a media playback system 100 distributed in an environment 101 (e.g., an automobile, vehicle, or other suitable environment). The media playback system 100 comprises one or more playback devices 110 (identified individually as playback devices 110a-n), one or more network microphone devices (“NMDs”) 120 (shown as exemplary NMD 120a), one or more control devices 130 (identified individually as control devices 130a and 130b), and one or more vehicle sensor components 140 (identified individually as vehicle sensor components 140a and 140b).

As used herein the term “playback device” can generally refer to a network device configured to receive, process, and output data of a media playback system. For example, a playback device can be a network device that receives and processes audio content. In some embodiments, a playback device includes one or more transducers or speakers powered by one or more amplifiers. In other embodiments, however, a playback device includes one of (or neither of) the speaker and the amplifier. For instance, a playback device can comprise one or more amplifiers configured to drive one or more speakers external to the playback device via a corresponding wire or cable.

Moreover, as used herein the term NMD (i.e., a “network microphone device”) can generally refer to a network device that is configured for audio detection. In some embodiments, an NMD is a stand-alone device configured primarily for audio detection. In other embodiments, an NMD is incorporated into a playback device (or vice versa).

The term “control device” can generally refer to a network device configured to perform functions relevant to facilitating user access, control, and/or configuration of the media playback system 100.

The term “vehicle sensor component” can generally refer to any device or component configured to obtain or provide data indicative of a vehicle state or operation. Examples include components that provide vehicle speed, acceleration, or other performance characteristics, as well as road noise, speech detection, or other audio parameters within or around the vehicle, as well as proximity or presence sensors to detect whether and where any passengers are located within the vehicle (e.g., weight sensors within a seat or other proximity sensor to determine a passenger location or position). These vehicle sensor components 140 can be communicatively coupled to one another and/or to other components of the vehicle media playback system 100 (e.g., via wired or wireless connection) such that the sensor component(s) 140 can provide signals indicative of vehicle conditions, state, or operation. As described in more detail below, in some implementations the media playback system 100 can automatically and dynamically modify audio playback characteristics based at least in part on a vehicle parameter obtained via one or more vehicle sensor components 140.

Each of the playback devices 110 is configured to receive audio signals or data from one or more media sources (e.g., one or more remote servers, one or more local devices) and play back the received audio signals or data as sound. The one or more NMDs 120 are configured to receive spoken word commands, and the one or more control devices 130 are configured to receive user input. In response to the received spoken word commands and/or user input, the media playback system 100 can play back audio via one or more of the playback devices 110. In certain embodiments, the playback devices 110 are configured to commence playback of media content in response to a trigger. For instance, one or more of the playback devices 110 can be configured to play back a morning playlist upon detection of an associated trigger condition (e.g., when a driver begins her morning commute). In some embodiments, for example, the media playback system 100 is configured to play back audio from a first playback device (e.g., the playback device 100a) in synchrony with a second playback device (e.g., the playback device 100b). Interactions between the playback devices 110, NMDs 120, and/or control devices 130 of the media playback system 100 configured in accordance with the various embodiments of the disclosure are described in greater detail below.

In the illustrated embodiment of FIG. 1A, the environment 101 comprises a vehicle having several playback devices 110 disposed about the vehicle. In the illustrated example, the playback devices 110 include a front left playback device 110a, a front center playback device 110b, a front right playback device 110c, a left playback device 110d, a right playback device 110e, and a rear center playback device 110f. Additionally, the media playback system 100 includes playback devices integrated into or otherwise coupled to passenger seats, specifically a driver seat playback device 110g, a front passenger seat playback device 110h, a rear left passenger seat playback device 110i, and a rear right passenger seat playback device 110j. Any number of playback devices 110 can be distributed through the vehicle, including along the frame, in or carried by doors, in the ceiling, coupled to seats, disposed underneath seats, in the trunk, dashboard, or otherwise. In various implementations, these seat-integrated playback devices 110 can be integrated into the corresponding headrest assembly such that the playback devices 110 are positioned just behind a passenger's head when the passenger is seated. As described in more detail below, with the use of appropriate transducer positioning and associated waveguides, audio produced by these headrest-mounted playback devices can provide enhanced audio that is particularly beneficial for the passenger in the corresponding seat.

While certain embodiments and examples are described below in the context of a vehicle environment (e.g., a sports utility vehicle, bus, car, a ship, a boat, an airplane, etc.), the technologies described herein may be implemented in other types of environments. In some embodiments, for example, the media playback system 100 can be implemented in a home environment, in one or more commercial settings (e.g., a restaurant, mall, airport, hotel, a retail or other store), multiple environments (e.g., a combination of home and vehicle environments), and/or another suitable environment where multi-zone audio may be desirable.

The media playback system 100 can comprise one or more playback zones, some of which may correspond to different regions within the environment 101. The media playback system 100 can be established with one or more playback zones, after which additional zones may be added, or removed to form, for example, the configuration shown in FIG. 1A. In some examples, all playback devices 110 are within the same zone such that all playback devices play back audio synchronously. In some implementations, however, one or more playback devices may be arranged within a separate zone and may output distinct audio. For instance, the driver seat playback device 110g may be established in its own zone while handling audio associated with a telephone call such that the telephone call audio is output only via the driver seat playback device 110g, while separate audio may be output via some or all of the other playback devices 110. Additional details regarding audio playback synchronization among playback devices and/or zones can be found, for example, in U.S. Pat. No. 8,234,395 entitled, “System and method for synchronizing operations among a plurality of independently clocked digital data processing devices,” which is incorporated herein by reference in its entirety.

To facilitate synchronous playback, the playback device(s) described herein may, in some embodiments, be configurable to operate in (and/or switch between) different modes such as an audio playback group coordinator mode and/or an audio playback group member mode. While operating in the audio playback group coordinator mode, the playback device may be configured to coordinate playback within the group by, for example, performing one or more of the following functions: (i) receiving audio content from an audio source, (ii) using a clock (e.g., a physical clock or a virtual clock) in the playback device to generate playback timing information for the audio content, (iii) transmitting portions of the audio content and playback timing for the portions of the audio content to at least one other playback device (e.g., at least one other playback device operating in an audio playback group member mode), (iv) transmitting timing information (e.g., generated using the clock to the at least one other playback device; and/or (v) playing back the audio content in synchrony with the at least one other playback device using the generated playback timing information and/or the clock. While operating in the audio playback group member mode, the playback device may be configured to perform one or more of the following functions: (i) receiving audio content and playback timing for the audio content from the at least one other device (e.g., a playback device operating in an audio playback group coordinator mode); (ii) receiving timing information from the at least one other device (e.g., a playback device operating in an audio playback group coordinator mode); and/or (iii) playing the audio content in synchrony with at least the other playback device using the playback timing for the audio content and/or the timing information.

### a. Suitable Media Playback System

FIG. 1B is a schematic diagram of the media playback system 100 and a cloud network 102. For ease of illustration, certain devices of the media playback system 100 and the cloud network 102 are omitted from FIG. 1B. One or more communication links 103 (referred to hereinafter as “the links 103”) communicatively couple the media playback system 100 and the cloud network 102.

The links 103 can comprise, for example, one or more wired networks, one or more wireless networks, one or more wide area networks (WAN) (e.g., the Internet), one or more local area networks (LAN) (e.g., one or more WIFI networks), one or more personal area networks (PAN) (e.g., one or more BLUETOOTH networks, Z-WAVE networks, wireless Universal Serial Bus (USB) networks, ZIGBEE networks, and/or IRDA networks), one or more telecommunication networks (e.g., one or more Global System for Mobiles (GSM) networks, Code Division Multiple Access (CDMA) networks, Long-Term Evolution (LTE) networks, 5G communication network networks, and/or other suitable data transmission protocol networks), etc. The cloud network 102 is configured to deliver media content (e.g., audio content, video content, photographs, social media content) to the media playback system 100 in response to a request transmitted from the media playback system 100 via the links 103. In some embodiments, the cloud network 102 is further configured to receive data (e.g., voice input data) from the media playback system 100 and correspondingly transmit commands and/or media content to the media playback system 100.

The cloud network 102 comprises computing devices 106 (identified separately as a first computing device 106a, a second computing device 106b, and a third computing device 106c). The computing devices 106 can comprise individual computers or servers, such as, for example, a media streaming service server storing audio and/or other media content, a voice service server, a social media server, a media playback system control server, etc. In some embodiments, one or more of the computing devices 106 comprise modules of a single computer or server. In certain embodiments, one or more of the computing devices 106 comprise one or more modules, computers, and/or servers. Moreover, while the cloud network 102 is described above in the context of a single cloud network, in some embodiments the cloud network 102 comprises a plurality of cloud networks comprising communicatively coupled computing devices. Furthermore, while the cloud network 102 is shown in FIG. 1B as having three of the computing devices 106, in some embodiments, the cloud network 102 comprises fewer (or more than) three computing devices 106.

The media playback system 100 is configured to receive media content from the networks 102 via the links 103. The received media content can comprise, for example, a Uniform Resource Identifier (URI) and/or a Uniform Resource Locator (URL). For instance, in some examples, the media playback system 100 can stream, download, or otherwise obtain data from a URI or a URL corresponding to the received media content. A network 104 communicatively couples the links 103 and at least a portion of the devices (e.g., one or more of the playback devices 110, NMDs 120, and/or control devices 130) of the media playback system 100. The network 104 can include, for example, a wireless network (e.g., a WiFi network, a Bluetooth, a Z-Wave network, a ZigBee, and/or other suitable wireless communication protocol network) and/or a wired network (e.g., a network comprising Ethernet, Universal Serial Bus (USB), and/or another suitable wired communication). As those of ordinary skill in the art will appreciate, as used herein, “WiFi” can refer to several different communication protocols including, for example, Institute of Electrical and Electronics Engineers (IEEE) 802.11a, 802.11b, 802.11 g, 802.11n, 802.11ac, 802.11ac, 802.11ad, 802.11af, 802.11ah, 802.11ai, 802.11aj, 802.11aq, 802.11ax, 802.11ay, 802.15, etc. transmitted at 2.4 Gigahertz (GHz), 5 GHz, and/or another suitable frequency.

In some embodiments, the network 104 comprises a dedicated communication network that the media playback system 100 uses to transmit messages between individual devices and/or to transmit media content to and from media content sources (e.g., one or more of the computing devices 106). In certain embodiments, the network 104 is configured to be accessible only to devices in the media playback system 100, thereby reducing interference and competition with other household devices. In other embodiments, however, the network 104 comprises an existing vehicle communication network (e.g., a vehicle WiFi network). In some embodiments, the links 103 and the network 104 comprise one or more of the same networks. In some aspects, for example, the links 103 and the network 104 comprise a telecommunication network (e.g., an LTE network, a 5G network). Moreover, in some embodiments, the media playback system 100 is implemented without the network 104, and devices comprising the media playback system 100 can communicate with each other, for example, via one or more direct or indirect connections, PANs, LANs, telecommunication networks, and/or other suitable communication links.

In some embodiments, audio content sources may be regularly added or removed from the media playback system 100. In some embodiments, for example, the media playback system 100 performs an indexing of media items when one or more media content sources are updated, added to, and/or removed from the media playback system 100. The media playback system 100 can scan identifiable media items in some or all folders and/or directories accessible to the playback devices 110, and generate or update a media content database comprising metadata (e.g., title, artist, album, track length) and other associated information (e.g., URIs, URLs) for each identifiable media item found. In some embodiments, for example, the media content database is stored on one or more of the playback devices 110, network microphone devices 120, and/or control devices 130.

In the illustrated embodiment of FIG. 1B, the playback devices 110a-110f form group 107a, while playback devices 110g-110j (i.e., the seat-mounted playback devices) can be separate from the group 107a. In various configurations and/or operating modes, all of the playback devices 110a-j can be grouped together for synchronous playback, whether on a temporary or permanent basis. In some implementations, however, some or all of the playback devices 110 (e.g., one or more of the seat-mounted playback devices 110g-110j or any other selected playback device) can be in a separate group such that separate audio can be played back. When arranged in the group 107a, the selected playback devices can be configured to play back the same or similar audio content in synchrony from one or more audio content sources. In certain embodiments, for example, the group 107a comprises a bonded zone in which the various playback devices 110a-110f assume different playback responsibilities (e.g., playing back left front, right front, center front, etc. audio channels, respectively, of multi-channel audio content). In other embodiments, however, the media playback system 100 omits the group 107a and/or other grouped arrangements of the playback devices 110.

The media playback system 100 can include at least one NMD 120a, which comprises one or more microphones configured to receive voice utterances from a user. In the illustrated embodiment of FIG. 1B, the NMD 120a can be integrated into the vehicle, for instance being mounted within the dashboard, within or or about the steering wheel, or any other suitable location. Optionally, an NMD can be integrated within one of the playback devices 110. The NMD 120a can be configured to receive voice input 121 from a user 123. In some embodiments, the NMD 120a transmits data associated with the received voice input 121 to a voice assistant service (VAS) configured to (i) process the received voice input data and (ii) transmit a corresponding command to the media playback system 100. In some aspects, for example, the computing device 106c comprises one or more modules and/or servers of a VAS (e.g., a VAS operated by one or more of SONOS®, AMAZON®, GOOGLE® APPLE®, MICROSOFT®). The computing device 106c can receive the voice input data from the NMD 120a via the network 104 and the links 103. In response to receiving the voice input data, the computing device 106c processes the voice input data (i.e., “Play Hey Jude by The Beatles”), and determines that the processed voice input includes a command to play a song (e.g., “Hey Jude”). The computing device 106c accordingly transmits commands to the media playback system 100 to play back “Hey Jude” by the Beatles from a suitable media service (e.g., via one or more of the computing devices 106) on one or more of the playback devices 110.

### b. Suitable Playback Devices

FIG. 1C is a block diagram of the playback device 110a comprising an input/output 111. The input/output 111 can include an analog I/O 111a (e.g., one or more wires, cables, and/or other suitable communication links configured to carry analog signals) and/or a digital I/O 111b (e.g., one or more wires, cables, or other suitable communication links configured to carry digital signals). In some embodiments, the analog I/O 111a is an audio line-in input connection comprising, for example, an auto-detecting 3.5 mm audio line-in connection. In some embodiments, the digital I/O 111b comprises a Sony/Philips Digital Interface Format (S/PDIF) communication interface and/or cable and/or a Toshiba Link (TOSLINK) cable. In some embodiments, the digital I/O 111b comprises a High-Definition Multimedia Interface (HDMI) interface and/or cable. In some embodiments, the digital I/O 111b includes one or more wireless communication links comprising, for example, a radio frequency (RF), infrared, WiFi, Bluetooth, or another suitable communication protocol. In certain embodiments, the analog I/O 111a and the digital I/O 111b comprise interfaces (e.g., ports, plugs, jacks) configured to receive connectors of cables transmitting analog and digital signals, respectively, without necessarily including cables.

The playback device 110a, for example, can receive media content (e.g., audio content comprising music and/or other sounds) from a local audio source 105 via the input/output 111 (e.g., a cable, a wire, a PAN, a Bluetooth connection, an ad hoc wired or wireless communication network, and/or another suitable communication link). The local audio source 105 can comprise, for example, a mobile device (e.g., a vehicle infotainment system, a smartphone, a tablet, a laptop computer) or another suitable audio component (e.g., a television, a desktop computer, an amplifier, a phonograph, a Blu-ray player, a memory storing digital media files). In some aspects, the local audio source 105 includes local music libraries on a smartphone, a computer, a networked-attached storage (NAS), and/or another suitable device configured to store media files. In certain embodiments, one or more of the playback devices 110, NMDs 120, and/or control devices 130 comprise the local audio source 105. In other embodiments, however, the media playback system omits the local audio source 105 altogether. In some embodiments, the playback device 110a does not include an input/output 111 and receives all audio content via the network 104.

The playback device 110a further comprises electronics 112, optionally a user interface 113 (e.g., one or more buttons, knobs, dials, touch-sensitive surfaces, displays, touchscreens), and one or more transducers 114 (referred to hereinafter as “the transducers 114”). The electronics 112 is configured to receive audio from an audio source (e.g., the local audio source 105) via the input/output 111, one or more of the computing devices 106a-c via the network 104 (FIG. 1B), amplify the received audio, and output the amplified audio for playback via one or more of the transducers 114. In some embodiments, the playback device 110a optionally includes one or more microphones 115 (e.g., a single microphone, a plurality of microphones, a microphone array) (hereinafter referred to as “the microphones 115”). In certain embodiments, for example, the playback device 110a having one or more of the optional microphones 115 can operate as an NMD configured to receive voice input from a user and correspondingly perform one or more operations based on the received voice input.

In the illustrated embodiment of FIG. 1C, the electronics 112 comprise one or more processors 112a (referred to hereinafter as “the processors 112a”), memory 112b, software components 112c, a network interface 112d, one or more audio processing components 112g (referred to hereinafter as “the audio components 112g”), one or more audio amplifiers 112h (referred to hereinafter as “the amplifiers 112h”), and power 112i (e.g., one or more power supplies, power cables, power receptacles, batteries, induction coils, Power-over Ethernet (POE) interfaces, and/or other suitable sources of electric power). In some embodiments, the electronics 112 optionally include one or more other components 112j (e.g., one or more sensors, video displays, touchscreens, battery charging bases).

The processors 112a can comprise clock-driven computing component(s) configured to process data, and the memory 112b can comprise a computer-readable medium (e.g., a tangible, non-transitory computer-readable medium, data storage loaded with one or more of the software components 112c) configured to store instructions for performing various operations and/or functions. The processors 112a are configured to execute the instructions stored on the memory 112b to perform one or more of the operations. The operations can include, for example, causing the playback device 110a to retrieve audio information from an audio source (e.g., one or more of the computing devices 106a-c (FIG. 1B)), and/or another one of the playback devices 110. In some embodiments, the operations further include causing the playback device 110a to send audio information to another one of the playback devices 110a and/or another device (e.g., the NMD 120a). Certain embodiments include operations causing the playback device 110a to pair with another of the one or more playback devices 110 to enable a multi-channel audio environment (e.g., a stereo pair, a bonded zone).

The processors 112a can be further configured to perform operations causing the playback device 110a to synchronize playback of audio content with another of the one or more playback devices 110. As those of ordinary skill in the art will appreciate, during synchronous playback of audio content on a plurality of playback devices, a listener will preferably be unable to perceive time-delay differences between playback of the audio content by the playback device 110a and the other one or more other playback devices 110. Additional details regarding audio playback synchronization among playback devices can be found, for example, in U.S. Pat. No. 8,234,395, which was incorporated by reference above.

In some embodiments, the memory 112b is further configured to store data associated with the playback device 110a, such as one or more zones and/or zone groups of which the playback device 110a is a member, audio sources accessible to the playback device 110a, and/or a playback queue that the playback device 110a (and/or another of the one or more playback devices) can be associated with. The stored data can comprise one or more state variables that are periodically updated and used to describe a state of the playback device 110a. The memory 112b can also include data associated with a state of one or more of the other devices (e.g., the playback devices 110, NMDs 120, control devices 130) of the media playback system 100. In some aspects, for example, the state data is shared during predetermined intervals of time (e.g., every 5 seconds, every 10 seconds, every 60 seconds) among at least a portion of the devices of the media playback system 100, so that one or more of the devices have the most recent data associated with the media playback system 100.

The network interface 112d is configured to facilitate a transmission of data between the playback device 110a and one or more other devices on a data network such as, for example, the links 103 and/or the network 104 (FIG. 1B). The network interface 112d is configured to transmit and receive data corresponding to media content (e.g., audio content, video content, text, photographs) and other signals (e.g., non-transitory signals) comprising digital packet data including an Internet Protocol (IP)-based source address and/or an IP-based destination address. The network interface 112d can parse the digital packet data such that the electronics 112 properly receives and processes the data destined for the playback device 110a.

In the illustrated embodiment of FIG. 1C, the network interface 112d comprises one or more wireless interfaces 112e (referred to hereinafter as “the wireless interface 112e”). The wireless interface 112e (e.g., a suitable interface comprising one or more antennae) can be configured to wirelessly communicate with one or more other devices (e.g., one or more of the other playback devices 110, NMDs 120, and/or control devices 130) that are communicatively coupled to the network 104 (FIG. 1B) in accordance with a suitable wireless communication protocol (e.g., WiFi, Bluetooth, LTE). In some embodiments, the network interface 112d optionally includes a wired interface 112f (e.g., an interface or receptacle configured to receive a network cable such as an Ethernet, a USB-A, USB-C, and/or Thunderbolt cable) configured to communicate over a wired connection with other devices in accordance with a suitable wired communication protocol. In certain embodiments, the network interface 112d includes the wired interface 112f and excludes the wireless interface 112e. In some embodiments, the electronics 112 excludes the network interface 112d altogether and transmits and receives media content and/or other data via another communication path (e.g., the input/output 111).

The audio processing components 112g are configured to process and/or filter data comprising media content received by the electronics 112 (e.g., via the input/output 111 and/or the network interface 112d) to produce output audio signals. In some embodiments, the audio processing components 112g comprise, for example, one or more digital-to-analog converters (DAC), audio preprocessing components, audio enhancement components, digital signal processors (DSPs), and/or other suitable audio processing components, modules, circuits, etc. In certain embodiments, one or more of the audio processing components 112g can comprise one or more subcomponents of the processors 112a. In some embodiments, the electronics 112 omits the audio processing components 112g. In some aspects, for example, the processors 112a execute instructions stored on the memory 112b to perform audio processing operations to produce the output audio signals.

The amplifiers 112h are configured to receive and amplify the audio output signals produced by the audio processing components 112g and/or the processors 112a. The amplifiers 112h can comprise electronic devices and/or components configured to amplify audio signals to levels sufficient for driving one or more of the transducers 114. In some embodiments, for example, the amplifiers 112h include one or more switching or class-D power amplifiers. In other embodiments, however, the amplifiers include one or more other types of power amplifiers (e.g., linear gain power amplifiers, class-A amplifiers, class-B amplifiers, class-AB amplifiers, class-C amplifiers, class-D amplifiers, class-E amplifiers, class-F amplifiers, class-G and/or class H amplifiers, and/or another suitable type of power amplifier). In certain embodiments, the amplifiers 112h comprise a suitable combination of two or more of the foregoing types of power amplifiers. Moreover, in some embodiments, individual ones of the amplifiers 112h correspond to individual ones of the transducers 114. In other embodiments, however, the electronics 112 includes a single one of the amplifiers 112h configured to output amplified audio signals to a plurality of the transducers 114. In some other embodiments, the electronics 112 omits the amplifiers 112h.

The transducers 114 (e.g., one or more speakers and/or speaker drivers) receive the amplified audio signals from the amplifier 112h and render or output the amplified audio signals as sound (e.g., audible sound waves having a frequency between about 20 Hertz (Hz) and 20 kilohertz (kHz)). In some embodiments, the transducers 114 can comprise a single transducer. In other embodiments, however, the transducers 114 comprise a plurality of audio transducers. In some embodiments, the transducers 114 comprise more than one type of transducer. For example, the transducers 114 can include one or more low frequency transducers (e.g., subwoofers, woofers), mid-range frequency transducers (e.g., mid-range transducers, mid-woofers), and one or more high frequency transducers (e.g., one or more tweeters). As used herein, “low frequency” can generally refer to audible frequencies below about 500 Hz, “mid-range frequency” can generally refer to audible frequencies between about 500 Hz and about 2 kHz, and “high frequency” can generally refer to audible frequencies above 2 kHz. In certain embodiments, however, one or more of the transducers 114 comprise transducers that do not adhere to the foregoing frequency ranges. For example, one of the transducers 114 may comprise a mid-woofer transducer configured to output sound at frequencies between about 200 Hz and about 5 kHz.

Additionally, one of ordinary skill in the art will appreciate that a playback device is not limited to the examples described herein. In some embodiments, for example, one or more playback devices 110 comprises wired or wireless headphones (e.g., over-the-ear headphones, on-ear headphones, in-ear earphones, bone conduction headphones, etc.). The headphone may comprise a headband coupled to one or more earcups. For example, a first earcup may be coupled to a first end of the headband and a second earcup may be coupled to a second end of the headband that is opposite the first end. Each of the one or more earcups may house any portion of the electronic components in the playback device, such as one or more transducers. Further, the one or more earcups may include a user interface for controlling operation of the headphone such as for controlling audio playback, volume level, and other functions. The user interface may include any of a variety of control elements such as buttons, knobs, dials, touch-sensitive surfaces, and/or touchscreens. An ear cushion may be coupled to each of the one or more earcups. The ear cushions may provide a soft barrier between the head of a user and the one or more earcups to improve user comfort and/or provide acoustic isolation from the ambient (e.g., provide passive noise reduction (PNR)). Additionally (or alternatively), the headphone may employ active noise reduction (ANR) techniques to further reduce the user's perception of outside noise during playback. In various examples, the playback device 110 can take the form of in-ear earphones that are configured to extend at least partially within a user's ears and be operated wirelessly and/or via a wire or cable.

In some instances, the headphone device may take the form of a hearable device. Hearable devices may include those headphone devices (e.g., ear-level devices) that are configured to provide a hearing enhancement function while also supporting playback of media content (e.g., streaming media content from a user device over a PAN, streaming media content from a streaming music service provider over a WLAN and/or a cellular network connection, etc.). In some instances, a hearable device may be implemented as an in-ear headphone device that is configured to playback an amplified version of at least some sounds detected from an external environment (e.g., all sound, select sounds such as human speech, etc.).

In some embodiments, one or more of the playback devices 110 comprise a docking station and/or an interface configured to interact with a docking station for personal mobile media playback devices. In certain embodiments, a playback device may be integral to another device or component such as a television, a lighting fixture, or some other device for indoor or outdoor use. In some embodiments, a playback device omits a user interface and/or one or more transducers. For example, FIG. 1D is a block diagram of a playback device 110p comprising the input/output 111 and electronics 112 without the user interface 113 or transducers 114.

FIG. 1E is a block diagram of a bonded playback device 110q comprising the playback device 110a (FIG. 1C) sonically bonded with the playback device 110f (e.g., a subwoofer) (FIG. 1A). In the illustrated embodiment, the playback devices 110a and 110i are separate ones of the playback devices 110 housed in separate enclosures. In some embodiments, however, the bonded playback device 110q comprises a single enclosure housing both the playback devices 110a and 110i. The bonded playback device 110q can be configured to process and reproduce sound differently than an unbonded playback device (e.g., the playback device 110a of FIG. 1C) and/or paired or bonded playback devices (e.g., the playback devices 1101 and 110m of FIG. 1B). In some embodiments, for example, the playback device 110a is a full-range playback device configured to render low frequency, mid-range frequency, and high frequency audio content, and the playback device 110i is a subwoofer configured to render low frequency audio content. In some aspects, the playback device 110a, when bonded with the first playback device, is configured to render only the mid-range and high frequency components of a particular audio content, while the playback device 110i renders the low frequency component of the particular audio content. In some embodiments, the bonded playback device 110q includes additional playback devices and/or another bonded playback device.

### c. Suitable Network Microphone Devices (NMDs)

FIG. 1F is a block diagram of the NMD 120a (FIGS. 1A and 1B). The NMD 120a includes one or more voice processing components 124 (hereinafter “the voice components 124”) and several components described with respect to the playback device 110a (FIG. 1C) including the processors 112a, the memory 112b, the power components 112i, and the microphones 115.

The NMD 120a optionally comprises other components also included in the playback device 110a (FIG. 1C), such as the user interface 113 and/or the transducers 114. In some embodiments, the NMD 120a is configured as a media playback device (e.g., one or more of the playback devices 110), and further includes, for example, one or more of the audio processing components 112g (FIG. 1C), the transducers 114, and/or other playback device components. In certain embodiments, the NMD 120a comprises an Internet of Things (IoT) device such as, for example, a thermostat, alarm panel, fire and/or smoke detector, etc. In some embodiments, the NMD 120a comprises the microphones 115, the voice processing 124, and only a portion of the components of the electronics 112 described above with respect to FIG. 1B. In some aspects, for example, the NMD 120a includes the processor 112a and the memory 112b (FIG. 1B), while omitting one or more other components of the electronics 112. In some embodiments, the NMD 120a includes additional components (e.g., one or more sensors, cameras, thermometers, barometers, hygrometers).

In some embodiments, an NMD 120 can be integrated into a playback device 110. FIG. 1G is a block diagram of a playback device 110r comprising an NMD 120d. The playback device 110r can comprise many or all of the components of the playback device 110a and further include the microphones 115 and voice processing 124 (FIG. 1F). The playback device 110r optionally includes an integrated control device 130c. The control device 130c can comprise, for example, a user interface (e.g., the user interface 113 of FIG. 1B) configured to receive user input (e.g., touch input, voice input) without a separate control device. In other embodiments, however, the playback device 110r receives commands from another control device (e.g., the control device 130a of FIG. 1B).

Referring again to FIG. 1F, the microphones 115 are configured to acquire, capture, and/or receive sound from an environment (e.g., the environment 101 of FIG. 1A) and/or a room in which the NMD 120a is positioned. The received sound can include, for example, vocal utterances, audio played back by the NMD 120a and/or another playback device, background voices, ambient sounds, etc. The microphones 115 convert the received sound into electrical signals to produce microphone data. The voice processing 124 receives and analyzes the microphone data to determine whether a voice input is present in the microphone data. The voice input can comprise, for example, an activation word followed by an utterance including a user request. As those of ordinary skill in the art will appreciate, an activation word is a word or other audio cue that signifying a user voice input. For instance, in querying the AMAZON® VAS, a user might speak the activation word “Alexa.” Other examples include “Ok, Google” for invoking the GOOGLE® VAS and “Hey, Siri” for invoking the APPLE® VAS.

After detecting the activation word, voice processing 124 monitors the microphone data for an accompanying user request in the voice input. The user request may include, for example, a command to control a third-party device, such as a thermostat (e.g., NEST® thermostat), an illumination device (e.g., a PHILIPS HUE® lighting device), or a media playback device (e.g., a Sonos® playback device). For example, a user might speak the activation word “Alexa” followed by the utterance “set the thermostat to 68 degrees” to set a temperature in a home (e.g., the environment 101 of FIG. 1A). The user might speak the same activation word followed by the utterance “turn on the living room” to turn on illumination devices in a living room area of the home. The user may similarly speak an activation word followed by a request to play a particular song, an album, or a playlist of music on a playback device in the home.

### d. Suitable Control Devices

FIG. 1H is a partially schematic diagram of the control device 130a (FIGS. 1A and 1i). As used herein, the term “control device” can be used interchangeably with “controller” or “control system.” Among other features, the control device 130a is configured to receive user input related to the media playback system 100 and, in response, cause one or more devices in the media playback system 100 to perform an action(s) or operation(s) corresponding to the user input. In the illustrated embodiment, the control device 130a comprises a smartphone (e.g., an iPhone™ an Android phone) on which media playback system controller application software is installed. In some embodiments, the control device 130a comprises, for example, a vehicle-integrated infotainment system, a vehicle audio head unit, a tablet (e.g., an iPad™), a computer (e.g., a laptop computer, a desktop computer), and/or another suitable device (e.g., an IoT device). In certain embodiments, the control device 130a comprises a dedicated controller for the media playback system 100. In other embodiments, as described above with respect to FIG. 1G, the control device 130a is integrated into another device in the media playback system 100 (e.g., one more of the playback devices 110, NMDs 120, and/or other suitable devices configured to communicate over a network).

The control device 130a includes electronics 132, a user interface 133, one or more speakers 134, and one or more microphones 135. The electronics 132 comprise one or more processors 132a (referred to hereinafter as “the processors 132a”), a memory 132b, software components 132c, and a network interface 132d. The processor 132a can be configured to perform functions relevant to facilitating user access, control, and configuration of the media playback system 100. The memory 132b can comprise data storage that can be loaded with one or more of the software components executable by the processor 302 to perform those functions. The software components 132c can comprise applications and/or other executable software configured to facilitate control of the media playback system 100. The memory 112b can be configured to store, for example, the software components 132c, media playback system controller application software, and/or other data associated with the media playback system 100 and the user.

The network interface 132d is configured to facilitate network communications between the control device 130a and one or more other devices in the media playback system 100, and/or one or more remote devices. In some embodiments, the network interface 132d is configured to operate according to one or more suitable communication industry standards (e.g., infrared, radio, wired standards including IEEE 802.3, wireless standards including IEEE 802.11a, 802.11b, 802.11 g, 802.11n, 802.11ac, 802.15, 4G, LTE). The network interface 132d can be configured, for example, to transmit data to and/or receive data from the playback devices 110, the NMDs 120, other ones of the control devices 130, one of the computing devices 106 of FIG. 1B, devices comprising one or more other media playback systems, etc. The transmitted and/or received data can include, for example, playback device control commands, state variables, playback zone and/or zone group configurations. For instance, based on user input received at the user interface 133, the network interface 132d can transmit a playback device control command (e.g., volume control, audio playback control, audio content selection) from the control device 304 to one or more of playback devices. The network interface 132d can also transmit and/or receive configuration changes such as, for example, adding/removing one or more playback devices to/from a zone, adding/removing one or more zones to/from a zone group, forming a bonded or consolidated player, separating one or more playback devices from a bonded or consolidated player, among others.

The user interface 133 is configured to receive user input and can facilitate ‘control of the media playback system 100. The user interface 133 includes media content art 133a (e.g., album art, lyrics, videos), a playback status indicator 133b (e.g., an elapsed and/or remaining time indicator), media content information region 133c, a playback control region 133d, and a zone indicator 133e. The media content information region 133c can include a display of relevant information (e.g., title, artist, album, genre, release year) about media content currently playing and/or media content in a queue or playlist. The playback control region 133d can include selectable (e.g., via touch input and/or via a cursor or another suitable selector) icons to cause one or more playback devices in a selected playback zone or zone group to perform playback actions such as, for example, play or pause, fast forward, rewind, skip to next, skip to previous, enter/exit shuffle mode, enter/exit repeat mode, enter/exit cross fade mode, etc. The playback control region 133d may also include selectable icons to modify equalization settings, playback volume, and/or other suitable playback actions. In the illustrated embodiment, the user interface 133 comprises a display presented on a touch screen interface of a smartphone (e.g., an iPhone™, an Android phone). In some embodiments, however, user interfaces of varying formats, styles, and interactive sequences may alternatively be implemented on one or more network devices to provide comparable control access to a media playback system.

The one or more speakers 134 (e.g., one or more transducers) can be configured to output sound to the user of the control device 130a. In some embodiments, the one or more speakers comprise individual transducers configured to correspondingly output low frequencies, mid-range frequencies, and/or high frequencies. In some aspects, for example, the control device 130a is configured as a playback device (e.g., one of the playback devices 110). Similarly, in some embodiments the control device 130a is configured as an NMD (e.g., one of the NMDs 120), receiving voice commands and other sounds via the one or more microphones 135.

The one or more microphones 135 can comprise, for example, one or more condenser microphones, electret condenser microphones, dynamic microphones, and/or other suitable types of microphones or transducers. In some embodiments, two or more of the microphones 135 are arranged to capture location information of an audio source (e.g., voice, audible sound) and/or configured to facilitate filtering of background noise. Moreover, in certain embodiments, the control device 130a is configured to operate as a playback device and an NMD. In other embodiments, however, the control device 130a omits the one or more speakers 134 and/or the one or more microphones 135. For instance, the control device 130a may comprise a device (e.g., a thermostat, an IoT device, a network device) comprising a portion of the electronics 132 and the user interface 133 (e.g., a touch screen) without any speakers or microphones.

### e. Suitable Playback Device Configurations

As noted previously, in various implementations one or more playback devices 110 can be bonded together. Bonded playback devices may have different playback responsibilities (e.g., channel responsibilities). For example, the playback devices 110a-j may be bonded so as to produce or enhance a surround-sound effect of audio content. In this example, the playback device 110a may be configured to play a front left channel audio component, the playback device 110b can be configured to play a front center channel audio component, the playback device 110c can be configured to play a front right channel audio component, and so forth.

Additionally, bonded playback devices may have additional and/or different respective speaker drivers. For instance, the playback device 110f can take the form of a subwoofer, and when bonded with other playback devices (e.g., playback device 110a), the other playback device(s) can be configured to render a range of mid to high frequencies and the subwoofer device 110f can be configured to render low frequencies. When unbonded, however, the playback device 110a can be configured to render a full range of frequencies.

Playback devices that are merged may not have assigned playback responsibilities, and may each render the full range of audio content the respective playback device is capable of. Nevertheless, merged devices may be represented as a single UI entity (i.e., a zone, as discussed above).

In some embodiments, an NMD is bonded or merged with another device so as to form a zone. In other embodiments, a stand-alone network microphone device may be in a zone by itself. In other embodiments, however, a stand-alone network microphone device may not be associated with a zone. Additional details regarding associating network microphone devices and playback devices as designated or default devices may be found, for example, in previously referenced U.S. patent application Ser. No. 15/438,749.

Zones of individual, bonded, and/or merged devices may be grouped to form a zone group. When grouped, the zones of individual and/or bonded playback devices may play back audio in synchrony with one another, as described in previously referenced U.S. Pat. No. 8,234,395. Playback devices may be dynamically grouped and ungrouped to form new or different groups that synchronously play back audio content.

Certain data may be stored in a memory of a playback device (e.g., the memory 112b of FIG. 1C) as one or more state variables that are periodically updated and used to describe the state of a playback zone, the playback device(s), and/or a zone group associated therewith. The memory may also include the data associated with the state of the other devices of the media system and shared from time to time among the devices so that one or more of the devices have the most recent data associated with the system.

In some embodiments, the memory may store instances of various variable types associated with the states. Variables instances may be stored with identifiers (e.g., tags) corresponding to type. For example, certain identifiers may be a first type “a1” to identify playback device(s) of a zone, a second type “b1” to identify playback device(s) that may be bonded in the zone, and a third type “c1” to identify a zone group to which the zone may belong.

In yet another example, the media playback system 100 may utilize variables or identifiers representing other associations of zones and zone groups, such as identifiers associated with areas. An area may involve a cluster of zone groups and/or zones not within a zone group. In one aspect, an area may be used to invoke a cluster of zone groups and/or zones that share one or more zones and/or zone groups of another cluster. In another aspect, this differs from a zone group, which does not share a zone with another zone group. Further examples of techniques for implementing areas may be found, for example, in U.S. application Ser. No. 15/682,506 filed Aug. 21, 2017 and titled “Room Association Based on Name,” and U.S. Pat. No. 8,483,853 filed Sep. 11, 2007, and titled “Controlling and manipulating groupings in a multi-zone media system.” Each of these applications is incorporated herein by reference in its entirety. In some embodiments, the media playback system 100 may not implement areas, in which case the system may not store variables associated with areas.

### III. Headrest Assemblies with Integrated Playback Devices

As noted previously, conventional automobile audio systems often fail to deliver a clear and immersive sound experience to all passengers, particularly those passengers in the rear seats. Arranging an audio playback device within a vehicle headrest allows audio to be output in close proximity to a passenger's ears, creating the possibility for increased clarity, spaciousness, and individualized audio experience. However, such headrest-integrated playback devices also present challenges, as the position of a passenger's ears relative to the playback device can vary from one passenger to the next or over time while a given passenger adjusts her seating position. If audio output via a headrest-integrated playback device is too narrowly directed toward a target location (e.g., at an intended position of a passenger's ears), the acoustic perception will vary drastically as a passenger moves away from the intended listening position. As described in more detail below, various examples of the present technology can address these and other challenges by providing audio playback devices with tailored waveguides that direct audio along sound axes that diverge from one another in the forward direction and are configured to pass over each of the passenger's shoulders. The inventors have discovered that this arrangement achieves improved spaciousness and clarity for the passenger, allows for individualized audio output, and also avoids the problems associated with narrowly targeting the passenger's ears directly such that small movements of variations dramatically alter the perceived audio output.

Another challenge associated with audio playback in a vehicle such as an automobile is the presence of ambient noise in the environment. The ambient noise can vary widely over time (e.g., depending on vehicle speed, whether windows are rolled down, sunroof is open, etc.). Additionally, while audio played back in a vehicle may generally be intended for out-loud listening by all passengers, in some instances it may be more appropriate to output the audio to only one or a subset of the passengers. For instance, if the driver is carrying on a telephone conversation, it may be desirable to output the telephone audio only to audio transducers directed specifically or primarily toward the driver. The presence of headrest-integrated audio playback devices can facilitate such passenger-by-passenger tailoring in audio output. In operation, modifying audio playback among the headrest-integrated audio playback devices (and/or among other playback devices within the vehicle media playback system) can provide a personalized listening environment for each seat.

### A. Example Audio Playback Devices for Use in Headrest Assemblies

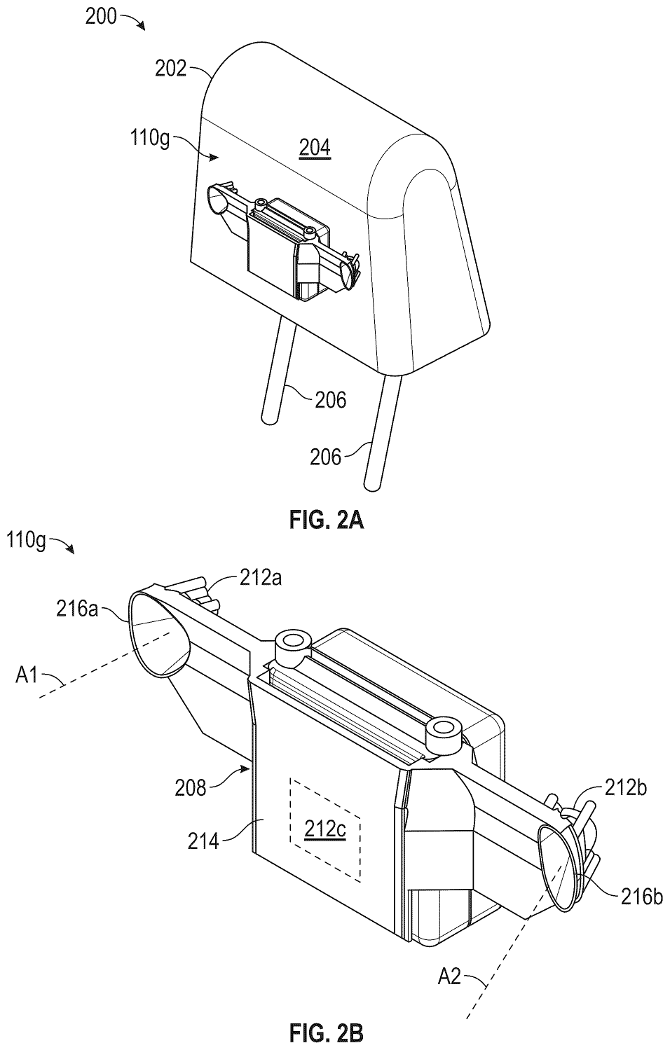

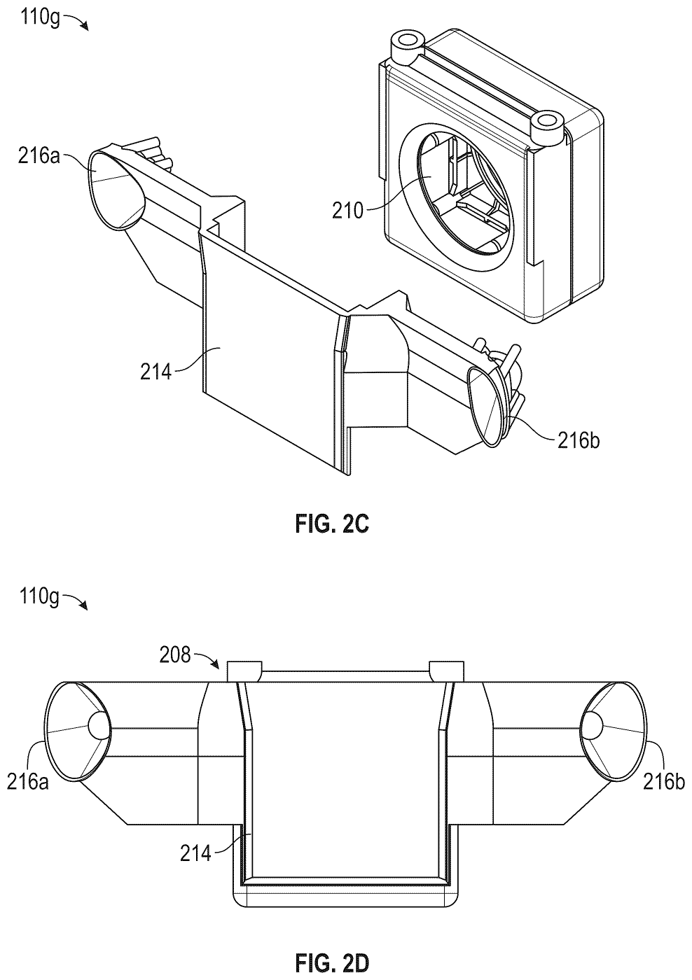

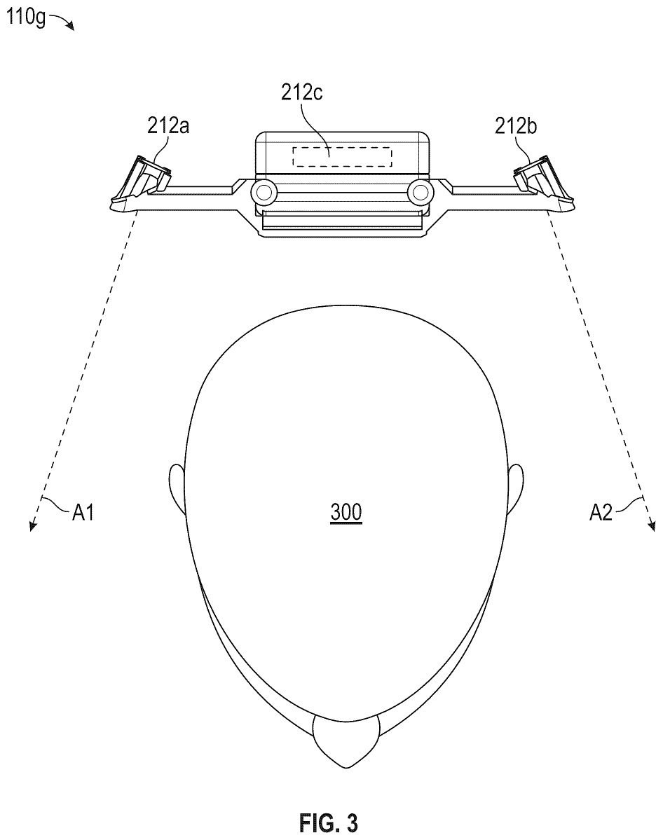

FIG. 2A shows a perspective view of a playback device 110g integrated into a headrest assembly 200. FIGS. 2B, 2C, and 2D show perspective, partially exploded, and front views, respectively, of the playback device 110g shown in FIG. 2A. FIG. 3 shows a top view of the headrest-integrated playback device 110g positioned relative to a passenger's head. Referring first to FIG. 2A, the headrest assembly 200 includes a headrest body 202 defining a forward surface 204 for contacting the rear side of a passenger's head or neck. In the illustrated example, downwardly projecting posts 206 can be used to removably couple to the headrest assembly 200 to a vehicle seat. In some implementations, electrical connections can be integrated into the posts 206, such that an electrical connection can be established between the audio playback device 110g and wiring or other electrical connectivity components disposed within the passenger seat (not shown).

The playback device 110g can be disposed within a cavity or receptacle defined by the headrest body 202. Optionally, some or all of the playback device 110g can be covered with an overlying material (e.g., cloth, leather, etc.) which can allow propagating sound to pass therethrough, but which hides the playback device 110g from view. In some implementations, some of the playback device 110g may be so hidden, while certain portions can be visible at the front surface 204 of the headrest assembly 200. For instance, the openings of the waveguide horns (described in more detail below) may be exposed at the front surface 204 of the headrest assembly 200, optionally covered with a speaker grille or other protective element.

As best seen in FIG. 2B, the playback device 110g can include a housing 208 that includes an interior chamber 210 (FIG. 2C). A plurality of audio transducers 212 can be disposed within or otherwise coupled to the housing 208. In the illustrated configuration, the playback device 110g includes a right transducer 212a configured to output audio along a right sound axis A1, a left transducer 212b configured to output audio along a right sound axis A2, and a center transducer 212c. These transducers 212 are shown only schematically in FIG. 2B. In various arrangements, the right transducer 212a and left transducer 212b can be tweeters or full-range audio transducers, while the center transducer 212c can be a woofer configured to output low-frequency audio content. In some implementations, the center transducer 212c can take the form of a dual-membrane device in which opposing membranes move in opposite directions so as to cancel out vibrations and mechanical stress. Examples of such dual-membrane speaker devices can be found in International Patent Publication No. WO 2022/0240284, entitled “Speaker Unit,” as well as in U.S. Pat. No. 11,297,415, titled “Low Profile Loudspeaker Device,” each of which is hereby incorporated by reference in its entirety.

The housing 208 of the audio playback device 110g can define a waveguide body 214 defining a right waveguide 216a and a left waveguide 216b. The right transducer 212a can be coupled to a throat (ear) portion of the right waveguide 216a and the left transducer 212b can be coupled to a throat (rear) portion of the left waveguide 216b. One function of the waveguides 216 is to efficiently couple the sound energy generated by the transducers 212 to the surrounding air, while also controlling the directivity and dispersion of the sound waves (e.g., to direct the sound waves along the sound axes A1 and A2). The waveguides 216 can act as an acoustic transformer, gradually increasing the cross-sectional area from the transducer's diaphragm (disposed at the horn's throat) to the horn's mouth at the opposite end, which allows for a better impedance match between the transducers 212 and the air. This improved matching results in enhanced sound projection and increased efficiency, as more of the transducer's energy is effectively transferred to the listening environment. Additionally, the shape and dimensions of the horn-like waveguides 216 can be configured to optimize the frequency response and directivity pattern of the audio transducers 212, enabling the desired sound characteristics to be achieved for various applications.

As shown in FIG. 2C, the housing 208 defines an interior chamber 210 which can enclose the center transducer 212c (not shown in FIG. 2C). As noted previously, the center transducer 212c can be a woofer configured to output low-frequency audio content. In the illustrated configuration, the center transducer 212c can be disposed within the chamber 210 such that a diaphragm of the center transducer 212c oscillates along a forward-backward axis. Because low-frequency content tends to be omnidirectional, a waveguide can be omitted for the center transducer 212c. In some implementations, the center transducer 212c can be utilized to provide haptic output in the form of vibrations that can be sensed by a seated passenger. Such haptic outputs can be used to provide notifications, for instance, such as alarms, informational notifications (e.g., incoming telephone call, navigation instructions such as approaching turn), safety alerts (e.g., lane-drift alerts, collision-warning alerts, sleep-warning alerts, etc.), or other suitable notifications. Additional details regarding haptic transducers suitable for use in automobile headrests (and/or other playback devices) can be found at in U.S. patent application Ser. No. 18/475,905, entitled “Haptic Signals,” where is hereby incorporated by reference in its entirety (and is also included as an Appendix herein).

As best seen in FIG. 3, the audio playback device 110g can be arranged such that the right sound axis A1 and left sound axis A2 sound axis extend adjacent right and left sides, respectively, of the head of the passenger 300 when the passenger 300 is seated. In the illustrated configuration, these sound axes can diverge from one another in the forward direction (e.g., with a divergence angle of at least about 5, 10, 15, 20, 25, 30, 35, 40, 45, or more degrees; and/or with a divergence angle of no more than about 50, 45, 40, 35, 30, 25, 20, 15, or 10 degrees). This configuration can beneficially achieve enhanced spaciousness while still providing audio sufficiently directed toward the seated passenger 300 for individualized audio output. As noted previously, some conventional approaches to headrest-integrated speakers may aim the sound axes directly towards a passenger's ears. However, such a configuration renders the acoustic perception of the passenger highly dependent upon the passenger's particular head position. Accordingly, when a passenger moves her head, the perceived audio can vary markedly and undesirably. Additionally, since passengers may vary in height, head size, head position when seated, etc., such precise directionality towards a passenger's ears can be difficult to achieve in a uniform manner. In contrast, as shown in FIG. 3, the audio playback device 110g can be configured such that the right and left sound axes A1 and A2 are oriented over the shoulders of the passenger 300. In some instances, these sound axes A1 and A2 can be directed along a height that is below the ears of the passenger 300, for instance at a passenger's neckline, which can similarly improve the psychoacoustic performance of the playback device 110g for the passenger 300.

In some implementations, the playback device 110g can be adjustable to tailor the sound directivity for different passenger heights, seating positions, or otherwise. For instance, the transducers 212 themselves can pivot, translate, or otherwise adjust position with respect to the headrest body 202. Additionally or alternatively, the waveguides 216 associated with one or more of the transducers 212 can be adjusted to alter one or more sound axes of the playback device 110g. For example, the waveguide body 214 can have moveable components (e.g., joints, extensible/collapsible arms, swellable segments, etc.) that allow the position of the waveguides 216 to move relative to each other. Additionally or alternatively, the waveguides 216 can include an internal movable divider or other such element that can be adjusted to alter the effective geometry of the horn to affect the output directivity. Additional details regarding such a moveable divider for a waveguide can be found in International Patent Publication No. WO/2022/0236240, entitled “Waveguides for Side-Firing Audio Transducers,” which is hereby incorporated by reference in its entirety.

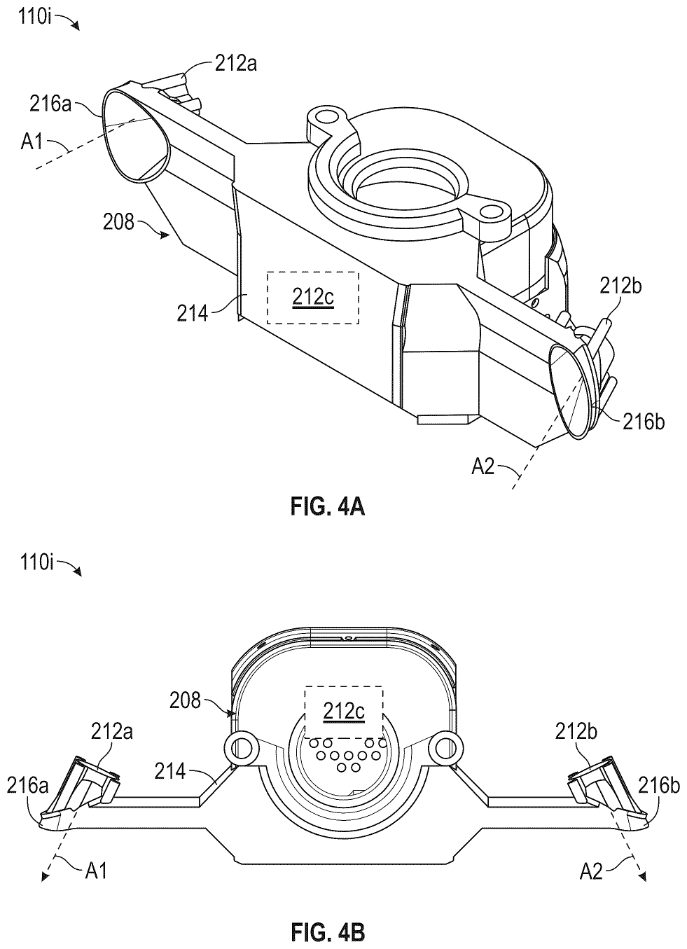

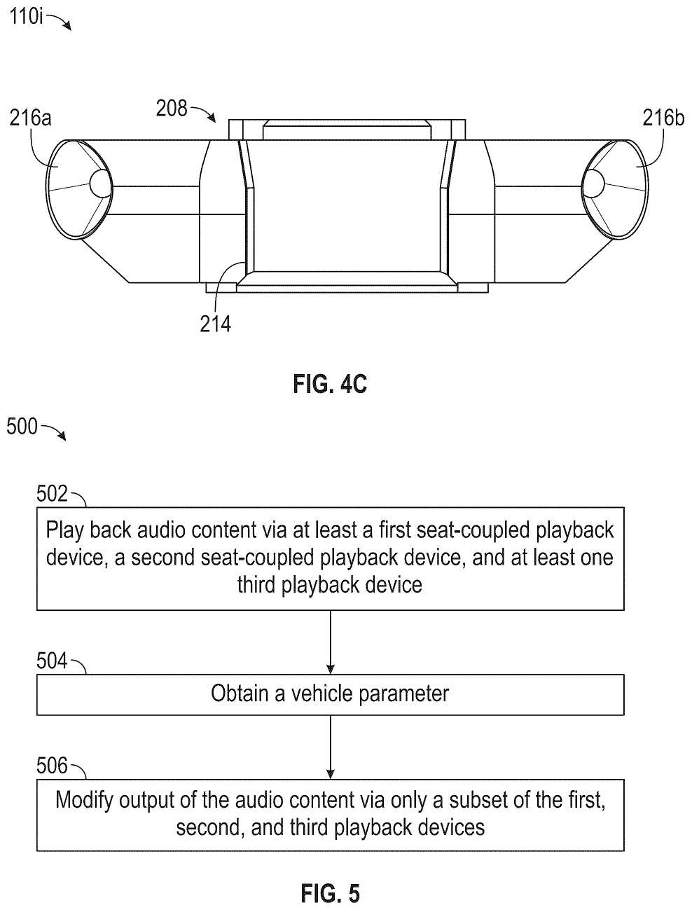

FIGS. 4A-4C illustrate perspective, top, and front views, respectively, of another example headrest-integrated audio playback device 110i. In many vehicles, the geometry of headrests can vary between front and rear seats. While front seats may have a higher headrest body (e.g., similar to that shown in FIG. 2A), rear seats sometimes have lower profile headrest bodies. Such low-profile headrests may necessitate a more compact audio playback device 110i. The audio playback device 110i can be configured similar to playback device 110g described above with respect to FIGS. 2A-3, except that the center transducer 212c can be oriented such that its excursion axis extends vertically (e.g., perpendicular to the orientation of the center transducer 212c in FIGS. 2A-2D). With this configuration, the housing 208 can have a lower height but a greater depth to accommodate the transducer 212c in this orientation.

### b. Example Methods for Modifying Audio Playback Based on Vehicle Parameter(s)

FIG. 5 illustrates an example method in accordance with the present technology. The method 500 can be implemented by any of the devices described herein, or any other devices now known or later developed. Various embodiments of the method 500 include one or more operations, functions, or actions illustrated by blocks. Although the blocks are illustrated in sequential order, these blocks may also be performed in parallel, and/or in a different order than the order disclosed and described herein. Also, the various blocks may be combined into fewer blocks, divided into additional blocks, and/or removed based upon a desired implementation.

In addition, for the method 500 and for other processes and methods disclosed herein, the flowcharts show functionality and operation of possible implementations of some embodiments. In this regard, each block may represent a component, a module, a segment, or a portion of program code, which includes one or more instructions executable by one or more processors for implementing specific logical functions or steps in the process. The program code may be stored on any type of computer readable medium, for example, such as a storage device including a disk or hard drive. The computer readable medium may include non-transitory computer readable media, for example, such as tangible, non-transitory computer-readable media that store data for short periods of time like register memory, processor cache, and Random-Access Memory (RAM). The computer readable medium may also include non-transitory media, such as secondary or persistent long-term storage, like read only memory (ROM), optical or magnetic disks, compact disc read only memory (CD-ROM), for example. The computer readable media may also be any other volatile or non-volatile storage systems. The computer readable medium may be considered a computer readable storage medium, for example, or a tangible storage device. In addition, for the methods and for other processes and methods disclosed herein, each block in FIGS. 5 and 6 may represent circuitry that is wired to perform the specific logical functions in the process.

FIG. 500 illustrates a method 500 for playing back audio via a vehicle media playback system in accordance with examples of the present technology. In various implementations, the vehicle media playback system can include a first headrest assembly including a first audio playback device, a second headrest assembly including a second audio playback device, and one or more third audio playback devices. The method 500 begins in block 502 with synchronously playing back audio content via the first audio playback device, the second playback device, and the third playback device(s). This can entail, for example, playing back audio synchronously via all the audio transducers of the vehicle media playback system.

In block 504, the method 500 involves obtaining a vehicle parameter. Among examples, the vehicle parameter can include a detected-sound parameter (e.g., detected road noise, speech presence detection, out-loud audio distinct from that being played back via the audio playback device, etc.), a user-presence parameter (e.g., user detected in a vehicle seat coupled to the headrest assembly, user(s) detected in other vehicle seat(s), user detected in proximity to audio playback device and/or to headrest body, etc.), or an audio content parameter (e.g., telephone audio, music, etc.). Such vehicle parameter(s) can be obtained via on-board vehicle sensors, sensors integrated into playback devices (e.g., microphones, accelerometers, etc.), from user input provided via a control device (e.g., a smartphone or vehicle-integrated controller such as a touchscreen), or in any other manner. In some examples, for instance, the controller comprises a vehicle head unit such as those described in U.S. Provisional Application No. 63/586,314, titled “Unified Content Experience,” which is hereby incorporated by reference in its entirety.

The method 500 continues in block 506 with modifying audio playback characteristics for only a subset of the devices based at least in part on the obtained vehicle parameter(s). As noted above, the vehicle parameter, which can be obtained via one or more vehicle sensors or other suitable data source. The modification can include varying audio playback characteristics of only a subset of the playback devices within the vehicle media playback system, for instance varying audio playback characteristics for only a single headrest-integrated playback device or a plurality of such headrest-integrated playback devices.

Modifying the audio output can include, for instance, performing active noise cancellation (optionally based on microphone data obtained via on-board microphones), inhibiting audio output via some or all of the transducers of a playback device, adjusting equalization settings of some or all of the transducers of a playback device, adjusting a playback volume, or any other suitable modification to audio playback, whether applied to that playback device alone or in combination with some or all of the other playback devices within the environment.

Additionally or alternatively to modifying audio output, other vehicle adjustments may be made, such as automatically adjusting a headrest position, adjusting a physical configuration of one or more of the audio transducers (e.g., to alter the directivity of audio output), or other suitable adjustments. In some implementations, a passenger's head position, ear-to-ear distance, seated position and orientation, or other parameter can be detected via one or more sensors (e.g., one or more cameras, ranging sensors, pressure sensors, or other suitable sensors), and such physical parameters of the passenger's position and orientation can be used to alter audio output.

In the case of portable playback devices disposed within the vehicle (e.g., headphones worn while in the vehicle, or vehicle-mounted playback devices that can be temporarily removed for use outside the vehicle), the tuning of audio playback for the portable device and/or for the remaining playback devices within the vehicle can be modified to adjust for the altered acoustic environment. Optionally, such devices can be automatically ungrouped from the playback devices within the vehicle once they are removed from the vehicle environment.

One example of such dynamic modification based on vehicle parameters relates to compensating for road noise. In a scenario where the vehicle is traveling on a rough or uneven road surface, the increased road noise can be detected by microphones integrated into the headrest assemblies or inferred from vehicle sensor data such as suspension activity. The audio playback system can then automatically adjust the EQ settings and/or raise the volume for the affected headrest audio playback devices to compensate for the increased background noise, ensuring that the passengers in those seats can still hear their audio content clearly without disruption.

In situations where the vehicle is exposed to external noise sources, such as heavy traffic or construction work, the audio playback system can employ active noise cancellation (ANC) technology to reduce the impact of the unwanted noise on the passengers' audio experience. By using the microphones integrated into the headrest assemblies to detect the external noise, the system can generate inverse sound waves and feed them through the headrest audio playback devices, effectively canceling out the noise for each passenger individually.

In another example, audio output is adjusted based on window position. When a passenger opens her window, the resulting wind noise can significantly impact the audio experience. By detecting the window position and monitoring the vehicle's speed, the audio playback system can determine which headrest audio playback devices are likely to be affected by wind noise. The system can then modify the audio output for those specific devices by increasing the volume and adjusting the EQ to emphasize frequencies that are less likely to be masked by the wind noise, providing a more enjoyable listening experience for the affected passengers.

As another example, telephone calls made via the vehicle media playback system can be intelligently routed to select playback devices. When an incoming telephone call is detected, the vehicle's audio playback system can route the call audio to the headrest audio playback device corresponding to the passenger who is intended to receive the call. This can be determined by user input via a vehicle control interface, such as a touchscreen, or by analyzing the caller ID and matching it to a pre-set configuration. By directing the call audio to only the selected passenger's headrest playback device, the system ensures that the conversation remains private and does not disturb other passengers.

In some implementations, the vehicle media playback system can utilize speech presence detection algorithms to identify when a passenger is speaking. If a passenger in a particular seat is detected to be speaking, the system can automatically lower the volume or pause the audio playback for that specific headrest audio playback device, allowing the passenger to converse without interference. Meanwhile, the audio playback for the other passengers remains unaffected, ensuring a seamless and uninterrupted experience for everyone else in the vehicle. In some implementations, audio playback for all passengers can be modified (e.g., volume reduced) in the presence of detected speech within the vehicle.

As another example, audio playback may be modified based on detection of passenger proximity. If the audio playback system detects that a passenger has moved her head away from the headrest, it can automatically lower the volume for that specific headrest audio playback device to prevent sound leakage and maintain a comfortable listening experience for nearby passengers. When the passenger returns to their original position, the system can restore the audio output to its previous level, ensuring that the passenger can continue enjoying their audio content without manual intervention.

In a scenario where a passenger leaves her seat, the audio playback system can detect the absence of the passenger and automatically pause or lower the volume of the audio output for that specific headrest audio playback device. This can prevent unnecessary sound output and conserve energy when the passenger is not present to listen to the audio content. When the passenger returns to her seat, the system can resume playback at the previous volume level.

Among examples, audio playback can also be modified based on the audio content characteristics. The audio playback system can analyze the type of audio content being played back and adjust the EQ settings accordingly for each headrest audio playback device. For example, if one passenger is listening to music while another is enjoying a podcast, the system can optimize the EQ for each playback device to suit the specific type of audio content. This ensures that each passenger receives the best possible audio experience tailored to their chosen content.

In another example implementation, if the vehicle media playback system detects out-loud audio, such as a conversation between passengers or an announcement from the vehicle's infotainment system, it can automatically lower the volume or pause the audio playback for the affected headrest audio playback devices. This allows passengers to hear the out-loud audio clearly without interference from their individual audio content. Once the out-loud audio has ended, the system can seamlessly resume playback at the previous volume levels.

In some cases, a vehicle media playback system may modify audio playback based on vehicle speed. As the vehicle's speed increases, the overall noise level inside the cabin typically rises due to factors such as wind noise and road noise. To compensate for this, the audio playback system can monitor the vehicle's speed and automatically adjust the volume of the headrest audio playback devices accordingly. By gradually increasing the volume as the vehicle's speed rises, the system ensures that passengers can continue to hear their audio content clearly without the need for manual adjustments. Conversely, when the vehicle slows down, the system can lower the volume to maintain a comfortable listening level.

These use cases are intended to describe only illustrative possibilities for modifying audio playback (whether of headrest-integrated playback devices or other playback devices) based on a vehicle parameter, such as vehicle operation, passenger presence, or other suitable parameter. Various other suitable modifications and vehicle parameters may likewise be utilized in accordance with the present technology.

### Iv. Conclusion

The above discussions relating to playback devices, controller devices, playback zone configurations, and media/audio content sources provide only some examples of operating environments within which functions and methods described below may be implemented. Other operating environments and configurations of media playback systems, playback devices, and network devices not explicitly described herein may also be applicable and suitable for implementation of the functions and methods.

The description above discloses, among other things, various example systems, methods, apparatus, and articles of manufacture including, among other components, firmware and/or software executed on hardware. It is understood that such examples are merely illustrative and should not be considered as limiting. For example, it is contemplated that any or all of the firmware, hardware, and/or software aspects or components can be embodied exclusively in hardware, exclusively in software, exclusively in firmware, or in any combination of hardware, software, and/or firmware. Accordingly, the examples provided are not the only ways) to implement such systems, methods, apparatus, and/or articles of manufacture.

Additionally, references herein to “embodiment” means that a particular feature, structure, or characteristic described in connection with the embodiment can be included in at least one example embodiment of an invention. The appearances of this phrase in various places in the specification are not necessarily all referring to the same embodiment, nor are separate or alternative embodiments mutually exclusive of other embodiments. As such, the embodiments described herein, explicitly and implicitly understood by one skilled in the art, can be combined with other embodiments.

The specification is presented largely in terms of illustrative environments, systems, procedures, steps, logic blocks, processing, and other symbolic representations that directly or indirectly resemble the operations of data processing devices coupled to networks. These process descriptions and representations are typically used by those skilled in the art to most effectively convey the substance of their work to others skilled in the art. Numerous specific details are set forth to provide a thorough understanding of the present disclosure. However, it is understood to those skilled in the art that certain embodiments of the present disclosure can be practiced without certain, specific details. In other instances, well known methods, procedures, components, and circuitry have not been described in detail to avoid unnecessarily obscuring aspects of the embodiments. Accordingly, the scope of the present disclosure is defined by the appended claims rather than the foregoing description of embodiments.

When any of the appended claims are read to cover a purely software and/or firmware implementation, at least one of the elements in at least one example is hereby expressly defined to include a tangible, non-transitory medium such as a memory, DVD, CD, Blu-ray, and so on, storing the software and/or firmware.

The present technology is illustrated, for example, according to various aspects described below. Various examples of aspects of the present technology are described as numbered examples for convenience. These are provided as examples and do not limit the present technology. It is noted that any of the dependent examples may be combined in any combination, and placed into a respective independent example. The other examples can be presented in a similar manner.

Example 1. A headrest assembly comprising: a headrest body defining a forward surface configured to contact a user's head or neck; and an audio playback device disposed within headrest body and facing in a forward direction, the audio playback device comprising: a left audio transducer; a left waveguide in fluid communication with the left audio transducer and configured to direct audio from the left audio transducer along a left sound axis; a right audio transducer; and a right waveguide in fluid communication with the right audio transducer and configured to direct audio from the right audio transducer along a right sound axis, wherein the left sound axis and the right sound axis diverge along the forward direction.

Example 2. The headrest assembly of any of the preceding Examples, wherein the audio playback device further comprises: one or more processors; and data storage having instructions stored thereon that, when executed by the one or more processors, cause the audio playback device to perform operations comprising: obtaining a vehicle parameter; and based at least in part on the vehicle parameter, modifying output of audio via the audio playback device.

Example 3. The headrest assembly of any of the preceding Examples, wherein the vehicle parameter comprises one or more of: a detected-sound parameter (e.g., detected road noise, speech presence detection, out-loud audio distinct from that being played back via the audio playback device, etc.); a user-presence parameter (e.g., user detected in a vehicle seat coupled to the headrest assembly, user(s) detected in other vehicle seat(s), user detected in proximity to audio playback device and/or to headrest body, etc.); or an audio content parameter (e.g., telephone audio, music, etc.).

Example 4. The headrest assembly of any of the preceding Examples, wherein modifying the audio output comprises one or more of: inhibiting audio output via the right audio transducer and/or the left audio transducer; adjusting equalization settings of the left audio transducer and/or the right audio transducer; or adjusting a playback volume.

Example 5. The headrest assembly of any of the preceding Examples, wherein the audio playback device further comprises one or more microphones, and wherein modifying the audio output comprises performing active noise cancellation based on sound detected via the one or more microphones.

Example 6. The headrest assembly of any of the preceding Examples, further comprising a center audio transducer.

Example 7. The headrest assembly of any of the preceding Examples, wherein the center audio transducer comprises a central woofer, the left audio transducer comprises a left tweeter, and the right audio transducer comprises a right tweeter.

Example 8. The headrest assembly of any of the preceding Examples, wherein the central woofer is configured to provide haptic output to a user in a vehicle seat coupled to the headrest body (e.g., vehicle notifications, alarms, lane-drift notifications, collision-warning notifications, sleep-warning notifications, etc.).

Example 9. A vehicle media playback system comprising: a first headrest assembly comprising a first audio playback device; a second headrest assembly comprising a second audio playback device; one or more third audio playback devices; one or more processors; and data storage having instructions stored thereon that, when executed by the one or more processors, cause the vehicle media playback system to perform operations comprising: synchronously playing back audio content via the first audio playback device, the second playback device, and the third playback device(s); obtaining a vehicle parameter; and based at least in part on the vehicle parameter, modifying output of the audio content via only a subset of the first, second, and third playback devices.

Example 10. The vehicle media playback system of any of the preceding Examples, wherein the vehicle parameter comprises one or more of: a detected-sound parameter (e.g., detected road noise, speech presence detection, out-loud audio distinct from that being played back via the audio playback device, etc.); a user-presence parameter (e.g., user detected in a vehicle seat coupled to the headrest assembly, user(s) detected in other vehicle seat(s), user detected in proximity to audio playback device and/or to headrest body, etc.); or an audio content parameter (e.g., telephone audio, music, etc.).

Example 11. The vehicle media playback system of any of the preceding Examples, wherein modifying the audio output comprises one or more of: inhibiting audio output via only a subset of the first, second, and third audio playback devices; adjusting equalization settings of only a subset of the first, second, and third audio playback devices; or adjusting a playback volume of only a subset of the first, second, and third audio playback devices.

Example 12. The vehicle media playback system of any of the preceding Examples, further comprising one or more microphones, and wherein modifying the audio output comprises performing active noise cancellation based on sound detected via the one or more microphones.

Example 13. The vehicle media playback system of any of the preceding Examples, wherein each of the first audio playback device and the second audio playback device comprises: a left audio transducer; a left waveguide in fluid communication with the left audio transducer and configured to direct audio from the left audio transducer along a left sound axis; a right audio transducer; and a right waveguide in fluid communication with the right audio transducer and configured to direct audio from the right audio transducer along a right sound axis, wherein the left sound axis and the right sound axis diverge along a forward direction.

Example 14. The vehicle media playback system of any of the preceding Examples, wherein each of the first audio playback device and the second audio playback device further comprises a central woofer.

Example 15. The vehicle media playback system of any of the preceding Examples, wherein the operations further comprise: causing only one of the central woofers to provide haptic output to a user in a vehicle seat (e.g., vehicle notifications, alarms, lane-drift notifications, collision-warning notifications, sleep-warning notifications, etc.).

Example 16. A method performed by a vehicle media playback system comprising a first headrest assembly including a first audio playback device, a second headrest assembly including a second audio playback device, and one or more third audio playback devices, the method comprising: synchronously playing back audio content via the first audio playback device, the second playback device, and the third playback device(s); obtaining a vehicle parameter; and based at least in part on the vehicle parameter, modifying output of the audio content via only a subset of the first, second, and third playback devices.

Example 17. The method of any of the preceding Examples, wherein the vehicle parameter comprises one or more of: a detected-sound parameter (e.g., detected road noise, speech presence detection, out-loud audio distinct from that being played back via the audio playback device, etc.); a user-presence parameter (e.g., user detected in a vehicle seat coupled to the headrest assembly, user(s) detected in other vehicle seat(s), user detected in proximity to audio playback device and/or to headrest body, etc.); or an audio content parameter (e.g., telephone audio, music, etc.).

Example 18. The method of any of the preceding Examples, wherein modifying the audio output comprises one or more of: inhibiting audio output via only a subset of the first, second, and third audio playback devices; adjusting equalization settings of only a subset of the first, second, and third audio playback devices; or adjusting a playback volume of only a subset of the first, second, and third audio playback devices.

Example 19. The method of any of the preceding Examples, wherein the vehicle media playback system further comprises one or more microphones, and wherein modifying the audio output comprises performing active noise cancellation based on sound detected via the one or more microphones.

Example 20. The method of any of the preceding Examples, wherein the first audio playback device and the second audio playback device each comprises a central woofer, the method further comprising: causing only one of the central woofers to provide haptic output to a user in a vehicle seat (e.g., vehicle notifications, alarms, lane-drift notifications, collision-warning notifications, sleep-warning notifications, etc.).

1. A headrest assembly comprising:
a headrest body defining a forward surface configured to contact a user's head or neck; and
an audio playback device disposed within headrest body and facing in a forward direction, the audio playback device comprising:
a left audio transducer;
a left waveguide in fluid communication with the left audio transducer and configured to direct audio from the left audio transducer along a left sound axis;
a right audio transducer; and
a right waveguide in fluid communication with the right audio transducer and configured to direct audio from the right audio transducer along a right sound axis,
wherein the left sound axis and the right sound axis diverge along the forward direction.

2. The headrest assembly of claim 1, wherein the audio playback device further comprises:
one or more processors; and
data storage having instructions stored thereon that, when executed by the one or more processors, cause the audio playback device to perform operations comprising:
obtaining a vehicle parameter; and
based at least in part on the vehicle parameter, modifying output of audio via the audio playback device.

3. The headrest assembly of claim 2, wherein the vehicle parameter comprises one or more of:
a detected-sound parameter;
a user-presence parameter; or
an audio content parameter.

4. The headrest assembly of claim 2, wherein modifying the audio output comprises one or more of:
inhibiting audio output via the right audio transducer and/or the left audio transducer;
adjusting equalization settings of the left audio transducer and/or the right audio transducer; or
adjusting a playback volume.

5. The headrest assembly of claim 2, wherein the audio playback device further comprises one or more microphones, and wherein modifying the audio output comprises performing active noise cancellation based on sound detected via the one or more microphones.

6. The headrest assembly of claim 1, further comprising a center audio transducer.

7. The headrest assembly of claim 6, wherein the center audio transducer comprises a central woofer, the left audio transducer comprises a left tweeter, and the right audio transducer comprises a right tweeter.

8. The headrest assembly of claim 7, wherein the central woofer is configured to provide haptic output to a user in a vehicle seat coupled to the headrest body.

9. A vehicle media playback system comprising:
a first headrest assembly comprising a first audio playback device;
a second headrest assembly comprising a second audio playback device;
one or more third audio playback devices;
one or more processors; and
data storage having instructions stored thereon that, when executed by the one or more processors, cause the vehicle media playback system to perform operations comprising:
synchronously playing back audio content via the first audio playback device, the second playback device, and the third playback device(s);
obtaining a vehicle parameter; and
based at least in part on the vehicle parameter, modifying output of the audio content via only a subset of the first, second, and third playback devices.

10. The vehicle media playback system of claim 9, wherein the vehicle parameter comprises one or more of:
a detected-sound parameter;
a user-presence parameter; or
an audio content parameter.

11. The vehicle media playback system of claim 9, wherein modifying the audio output comprises one or more of:
inhibiting audio output via only a subset of the first, second, and third audio playback devices;
adjusting equalization settings of only a subset of the first, second, and third audio playback devices; or
adjusting a playback volume of only a subset of the first, second, and third audio playback devices.

12. The vehicle media playback system of claim 9, further comprising one or more microphones, and wherein modifying the audio output comprises performing active noise cancellation based on sound detected via the one or more microphones.

13. The vehicle media playback system of claim 9, wherein each of the first audio playback device and the second audio playback device comprises:
a left audio transducer;
a left waveguide in fluid communication with the left audio transducer and configured to direct audio from the left audio transducer along a left sound axis;
a right audio transducer; and
a right waveguide in fluid communication with the right audio transducer and configured to direct audio from the right audio transducer along a right sound axis,
wherein the left sound axis and the right sound axis diverge along a forward direction.

14. The vehicle media playback system of claim 13, wherein each of the first audio playback device and the second audio playback device further comprises a central woofer.

15. The vehicle media playback system of claim 14, wherein the operations further comprise:
causing only one of the central woofers to provide haptic output to a user in a vehicle seat.

16. A method performed by a vehicle media playback system comprising a first headrest assembly including a first audio playback device, a second headrest assembly including a second audio playback device, and one or more third audio playback devices, the method comprising:
synchronously playing back audio content via the first audio playback device, the second playback device, and the third playback device(s);
obtaining a vehicle parameter; and
based at least in part on the vehicle parameter, modifying output of the audio content via only a subset of the first, second, and third playback devices.

17. The method of claim 16, wherein the vehicle parameter comprises one or more of:
a detected-sound parameter;
a user-presence parameter; or
an audio content parameter.

18. The method of claim 16, wherein modifying the audio output comprises one or more of:
inhibiting audio output via only a subset of the first, second, and third audio playback devices;
adjusting equalization settings of only a subset of the first, second, and third audio playback devices; or
adjusting a playback volume of only a subset of the first, second, and third audio playback devices.

19. The method of claim 16, wherein the vehicle media playback system further comprises one or more microphones, and wherein modifying the audio output comprises performing active noise cancellation based on sound detected via the one or more microphones.

20. The method of claim 16, wherein the first audio playback device and the second audio playback device each comprises a central woofer, the method further comprising:
causing only one of the central woofers to provide haptic output to a user in a vehicle seat.
